(19) United States
(12) Patent Application Publication
(10) Pub. No.: US 2003/0029194 A1
(43) Pub. Date: Feb. 13, 2003

(54) Pyrogenic oxides doped with erbium oxide

(76) Inventors: Helmut Mangold, Rodenbach (DE); Rainer Golchert, Dieburg (DE); Roland Schilling, Freigericht (DE)

Correspondence Address: SMITH, GAMBRELL & RUSSELL, LLP, 1850 M STREET, N.W., SUITE 800, WASHINGTON, DC, 20036, US

(21) Appl. No.: 10/191,297

(22) Filed: Jul. 10, 2002

(30) Foreign Application Priority Data
Jul. 14, 2001 (DE) 101 34 382.5

(51) Int. Cl. C03B 37/016

(52) U.S. Cl. 65/17.2; 65/17.4; 65/395; 252/301.4 R; 252/301.4 F; 501/27; 501/50; 501/64; 501/78

(57) ABSTRACT

Pyrogenically produced oxides of metals and/or metalloids doped with erbium oxide, in which the base component is a pyrogenically produced oxide doped with erbium oxide in an amount of 0.000001 to 40 wt %, in which the BET surface of the doped oxide lies between 1 and 1000 m²/g, are produced by feeding an aerosol into a flame, as used for production of pyrogenic oxide, in which an erbium salt solution is used as the starting product for the aerosol, the aerosol being produced by atomization with an aerosol generator, this aerosol is mixed homogeneously before reaction with a gas mixture for flame oxidation or flame hydrolysis, the aerosol-gas mixture is then allowed to react in a flame, and the formed pyrogenic oxides doped with erbium oxide are separated from the gas stream in a known fashion. The pyrogenic oxide of metals and/or metalloids doped with erbium oxide can be used as glass raw material.

### INTRODUCTION AND BACKGROUND

The present invention relates to pyrogenic oxides doped with erbium oxide, a method for their production and their use.

The invention also concerns the production of glass or glass fibers from pyrogenically produced powders doped with erbium oxides.

It is known to use erbium in the production of optical fibers (Pawlik et al.: Adv. Sci. Technol. (Faenza, Italy) Innovative Light Emitting Materials, pages 243-248).

### SUMMARY OF INVENTION

The invention resides in pyrogenically produced oxides of metals and/or metalloids doped with erbium oxides, wherein the base component is a pyrogenically produced oxide doped with erbium oxide in an amount of 0.000001 to 40 wt %., the amount of doping preferably lying in the range from 1 to 20,000 ppm, in which the BET surface of the doped oxide is in the range of 1 to 1000 m²/g.

Pyrogenic production of the oxides can occur by flame oxidation, or preferably by flame hydrolysis.

In a preferred variant of the invention, the erbium can be doped by means of an aerosol.

In one variant of the invention, the pyrogenically produced oxides of metals or metalloids doped with erbium oxide are characterized by the fact that the base component is a pyrogenically produced oxide doped with erbium oxide in an amount of 0.000001 to 40 wt %, in which the amount of doping preferably lies in the range from 1 to 20,000 ppm, and the pH value of the doped pyrogenic oxide, measured in a 4% aqueous dispersion, is more than 5, and the BET surface of the doped oxide is from 1 to 1000 m 2/g.

In another variant of the invention, the pyrogenically produced oxides of metals or metalloids doped with erbium oxide are characterized by the fact that the base component of the pyrogenically produced oxide is doped with erbium oxide in an amount of 0.000001 to 40 wt %, in which the amount of doping preferably lies in the range from 1 to 20,000 ppm and the dibutyl phthalate absorption of the powder is less than 100 g/100 g, and the BET surface of the doped oxide is from 1 to 1000 m²/g.

Another aspect of the invention relates to a method for the production of the pyrogenic oxides doped with erbium oxide according to the invention, characterized by the fact that an aerosol is fed into a flame, as used to produce pyrogenic oxide using volatilizable salts of metals and/or metalloids, in which an erbium salt solution is used as starting product for the aerosol. The aerosol is produced by atomization through an aerosol generator, preferably according to the two-fluid method. This aerosol is homogeneously mixed before the reaction with the gas mixture fed into the flame, and then the aerosol gas mixture is made to react in a flame and the formed pyrogenic oxides doped with erbium oxide are separated from the gas stream in a known fashion.

In one embodiment of the invention, the pyrogenic production can occur similarly to flame oxidation, according to flame hydrolysis.

In a preferred variant of the invention, an apparatus and the method according to DE 196 50 500 for the production of the silicon dioxide doped with erbium oxide according to the invention can be used. This document is relied on and incorporated herein by reference.

Volatilizable compounds of silicon, aluminum, titanium, etc., like chlorides, methyl chorides or alkyl esters, can be used as starting materials for producing the oxides of metals and/or metalloids according to the invention.

In a preferred variant of the invention, the chlorides of metals and/or metalloids are used.

Both erbium nitrate and erbium chloride can be used as erbium salt.

It was found that when erbium salts are used as doping components, this erbium is homogeneously incorporated into the primary particles of the pyrogenic oxide, so that the formed oxide of metals and/or metalloids is excellently suited for producing green compacts, from which glasses can then be sintered (for example, after production of a sol). These green compacts are suitable for producing optical fibers or other optical components (optical switches or amplifiers).

Another aspect of the invention relates to a green compact or glass, produced from an oxide of metals and/or metalloids according to the invention, characterized by the fact that a pyrogenic silicon dioxide doped with erbium oxide according to the invention is used as a silicon dioxide-containing component, which, after the steps of dispersal to a sol, gelling, then drying to a green compact and then sintering, leads to a densely sintered bubble-free glass with homogeneous erbium oxide distribution.

Another aspect of the invention relates to layers, characterized by the fact that at least one layer component is a pyrogenic oxide of metals and/or metalloids doped with erbium oxide according to the invention, in which these layers can be densely sintered by heat treatment.

Another aspect of the invention relates to the use of the pyrogenic oxides of metals and/or metalloids doped with erbium oxide according to the invention as glass raw materials, as optical fibers doped as solid material, as a shell or core, as optical switches, as optical amplifiers, as other optical articles, as lenses, glasses, in the jewelry industry.

Another aspect of the invention relates to the use of pyrogenic oxides of metals and/or metalloids doped with erbium oxide according to the invention as a filler, as a support, as a catalytically active substance, as a starting material for producing dispersions, as a polishing material (CMP applications), as a ceramic raw material, in the electronics industry, in the cosmetics industry, as an additive in the silicone and rubber industry, to adjust the rheology of liquid systems, for heat protection stabilization, in the paint industry.

Another aspect of the invention relates to an aqueous dispersion of the pyrogenic oxides of metals and/or metalloids doped with erbium or erbium oxide according to the invention.

In a preferred variant, silicon dioxide is used as the pyrogenically produced oxide.

### BRIEF DESCRIPTION OF DRAWINGS

The present invention will be further understood with reference to the accompanying drawings wherein:

FIG. 1 is an electron photomicrograph of the powder of example 1 at a magnification of 50,000;

FIG. 2 is an electron photomicrograph of the powder of example 1 magnified 100,000 times, and;

FIG. 3 is an electron photomicrograph of the powder of example 1 magnified 200,000 times.

### DETAILED DESCRIPTION OF INVENTION

The various aspects of the invention are further explained and described with reference to the following examples.

### EXAMPLES

A burner arrangement as described in DE OS 196 50 500 is used.

### Example 1

(Doping with an Aerosol Produced from a Solution of Erbium Trichloride)

4.44 kg/h SiCl₄ are evaporated at about 130° C. and transferred to the central tube of the burner of known design according to DE 196 50 500. 3.7 Nm³/h of hydrogen and 4.5 Nm³/h air and 0.7 Nm³/h oxygen are additionally fed into this tube. The gas mixture flows from the inner burner nozzle and burns in the burner space of a water-cooled flame tube. In the outer nozzle that encloses the central nozzle, 0.3 Nm³/h (secondary) hydrogen and 0.2 Nm³/h nitrogen are additionally fed to avoid agglomeration.

About 10 Nm³/h air are additionally drawn in from the surroundings into the flame tube under a slight underpressure (open burner method).

The second gas component introduced to the actual tube consists of an aerosol produced from an 11.4% aqueous ErCl₃ solution.

A two-fluid nozzle that delivers an atomization output of 270 g/h aerosol serves as the aerosol generator. The aqueous salt aerosol is guided by means of 3.5 Nm³/h carrier air through lines heated on the outside and leaves the inner nozzle with an outlet temperature of about 1 80° C. The erbium salt-containing aerosol is introduced to the flame and alters the produced pyrogenic silica according to its properties.

After flame hydrolysis, the reaction gases in the formed pyrogenic silica doped with erbium oxide are drawn off through a cooling system by applying a partial vacuum and the particle gas stream is cooled to about 100 to 160° C. The solids are separated from the exhaust stream in a filter or cyclone.

The formed pyrogenic silica doped by means of aerosol with erbium oxide occurs as a white to slightly pink, finely divided powder. In a further step at temperatures between 400 and 700° C., still adhering hydrochloric acid residues are removed from the doped silica by treatment with steam-containing air.

The BET surface of the pyrogenic silica is 48 m²/g. The content of analytically determined erbium oxide is 0.528 wt %.

The production conditions are summarized in Table 1. Additional analytical data of the silica so obtained are shown in Table 2.

### Example 2

(Doping with an Aerosol Produced from a Solution of Erbium Trinitrate)

The procedure under Example 1 is followed:

4.44 kg/h SiCl₄ are evaporated at about 130° C. and transferred to the central tube of a burner of known design according to DE OS 196 50 500. 3.7 Nm³/h hydrogen and 4.5 Nm³/h air and 0.9 Nm³/h oxygen are additionally fed into this tube. This gas mixture flows from the inner burner nozzle and burns in the burner space of a water-cooled flame tube.

In the outer nozzle that surrounds the central nozzle, 0.3 Nm³/h (secondary) hydrogen and 0.2 Nm³/h nitrogen are additionally fed to avoid agglomeration.

About 10 Nm³/h air are additionally drawn in from the surroundings into the flame tube under a slight underpressure. (Open burner method).

The second gas component introduced to the axial tube consists of an aerosol produced from a 14.3% aqueous Er(NO₃)₃ solution.

A two-fluid nozzle that generates an atomization output of 235 g/h aerosol is used as the aerosol generator. The aqueous salt aerosol is fed by means of 3.5 Nm³/h carrier air through lines heated on the outside and leaves the inner nozzle with an outlet temperature of about 180° C. The erbium salt-containing aerosol is introduced to the flame and modifies the produced pyrogenic silica according to its properties.

After flame hydrolysis, the reaction gases in the form pyrogenic silica doped with erbium oxide are passed through a cooling system by applying a partial vacuum and the particle gas stream is cooled to about 100 to 160° C. The solids are separated from the exhaust stream in a filter or cyclone.

The formed pyrogenic silica doped with erbium oxide by means of aerosol occurs as a white to slightly pink, finely divided power. In an additional step at temperatures between 400 and 700° C., adhering hydrochloric acid residues are removed from the silica by treatment with steam-containing air.

The BET surface of the pyrogenic silica is 62 m²/g.

The production conditions are summarized in Table 1. Additional analytical data of the so obtained silica are shown in Table 2.

### Example 3

(Doping with an Aerosol Produced from a Solution of Erbium Trinitrate)

The procedure under Example 1 is followed:

4.44 kg/h SiCl₄ are evaporated at about 130° C. and introduced to the central tube of a burner of known design according to DE OS 196 50 500. 3.7 Nm³/h hydrogen and 4.5 Nm³/h air and 0.9 Nm³/h oxygen are additionally fed into this tube. This gas mixture flows from the inner burner nozzle and burns in the burner space of a water-cooled flame tube.

In the outer nozzle that encloses the central nozzle, 0.3 Nm³/h (secondary) hydrogen and 0.2 Nm³/h nitrogen are additionally fed to avoid agglomeration.

About 10 Nm³/h air are additionally drawn in from the surroundings into the flame tube under a slight underpressure. (Open burner method).

The second gas component introduced to the axial tube consists of an aerosol produced from a 14.3% aqueous Er(NO₃)₃ solution.

A two-fluid nozzle that yields an atomization output of 210 g/h aerosol serves as the aerosol generator. The aqueous salt aerosol is guided through lines heated on the outside with 3.5 Nm³/h carrier air and leaves the inner nozzle with an outlet temperature of about 180° C. The erbium salt-containing aerosol is introduced to the flame and modifies the produced pyrogenic silica according to its properties.

After flame hydrolysis, the reaction gases in the formed pyrogenic silica doped with erbium oxide are drawn through a cooling system by applying a partial vacuum and the particle gas stream is cooled to about 100 to 160° C. The solids are separated from the exhaust stream in a filter or cyclone.

The pyrogenic silica doped with erbium oxide formed by means of aerosol occurs as a white to slightly pink, finely divided power. In an additional step at temperatures between 400 and 700° C., still adhering hydrochloric acid residues are removed from the silica by treatment with steam-containing air.

The BET surface of the pyrogenic silica is 75 m²/g.

The production conditions are summarized in Table 1. Additional analytical data of the silica so obtained are shown in Table 2.

TABLE 1
Experimental conditions for production of doped pyrogenic silica

| | | | | | | | | Erbium | | | |
|---|---|---|---|---|---|---|---|---|---|---|---|
| | | Primary | O₂ | H₂ | H₂ | N₂ | Gas | salt | Aerosol | Air | |
| | SiCl₄, | air | additional | core | shell | shell | temperature | solution, | amount, | aerosol, | BET |
| No | kg/h | Nm³/h | Nm³/h | Nm³/h | Nm³/h | Nm³/h | ° C. | wt % | g/h | Nm³/h | m²/g |
| 1 | 4.44 | 4.5 | 0.7 | 3.7 | 0.3 | 0.2 | 120 | 11.4 ErCl₃ | 270 | 3.5 | 48 |
| 2 | 4.44 | 4.5 | 0.9 | 3.7 | 0.3 | 0.2 | 112 | 14.3 Er(NO₃)₃ | 235 | 3.5 | 62 |
| 3 | 4.44 | 4.5 | 0.9 | 3.7 | 0.3 | 0.2 | 110 | 14.3 Er(NO₃)₃ | 210 | 3.5 | 75 |

Explanation: Primary air = amount of air in central tube; H₂ core = hydrogen in central tube; gas temperature = gas temperature at the nozzle of central tube; aerosol amount = mass flow rate of the salt solution converted to aerosol form; air aerosol = carrier gas amount (air) of the aerosol

TABLE 2
Analytical data of the samples obtained according to Examples 1 to 3

| | | pH at | Erbium | DBP in g/100 g | Bulk | |
|---|---|---|---|---|---|---|
| | BET | 4% aqueous | content in | with 16 g | density, | Tamped |
| No. | m²/g | dispersion | wt % as Er₂O₃ | weighed amount | g/L | density, g/L |
| 1 | 48 | 5.4 | 0.528 | 59 | 62 | 83 |
| 2 | 62 | 4.38 | 0.112 | 64 | 64 | 81 |
| 3 | 75 | 4.35 | 0.115 | 83 | 60 | 76 |

Explanation: pH 4% suspension = pH value of 4% aqueous suspension; DBP = dibutyl phthalate absorption

Production of Glass and Glass Molded Articles from Powders Doped with Erbium Oxide

A glass blank is produced from the powder of Example 1 of this invention, according to the procedure of U.S. Pat. No. 5,379,364.

### Example 4

Production of Glass Blank

A dispersion is produced from 460 g of the powder of Example 1 doped with erbium oxide according to the invention by addition of 540 mL distilled water, to which 51.5 mL of a 25% aqueous solution of tetramethylammonium hydroxide (TMAH) is added, so that a pH value of 12 results.

After 20 h, 0.97 g polyethyloxazoline and 4 g glycerol are added to the mixture and agitated for 30 min. After addition of 9.65 mL methyl formate, the solution is immediately cast into an elongated mold (stainless steel), where it gels within 1 min. After another 10 min, the blank is removed from the mold and dried in air at room temperature for 7 days, and then dewatered for an additional 24 h in a drying cabinet at 150° C. and dried for another 4 h at 500° C. The density of this green compact, is determined by helium pycnometry to be 0.81 g/cm³.

Sintering of the green compact occurs in a sintering furnace during a residence time of 16 h at 1400° C. After sintering, a dense, bubble-free and transparent glass body is obtained that contains erbium oxide uniformly distributed in a glass.

EM Recording

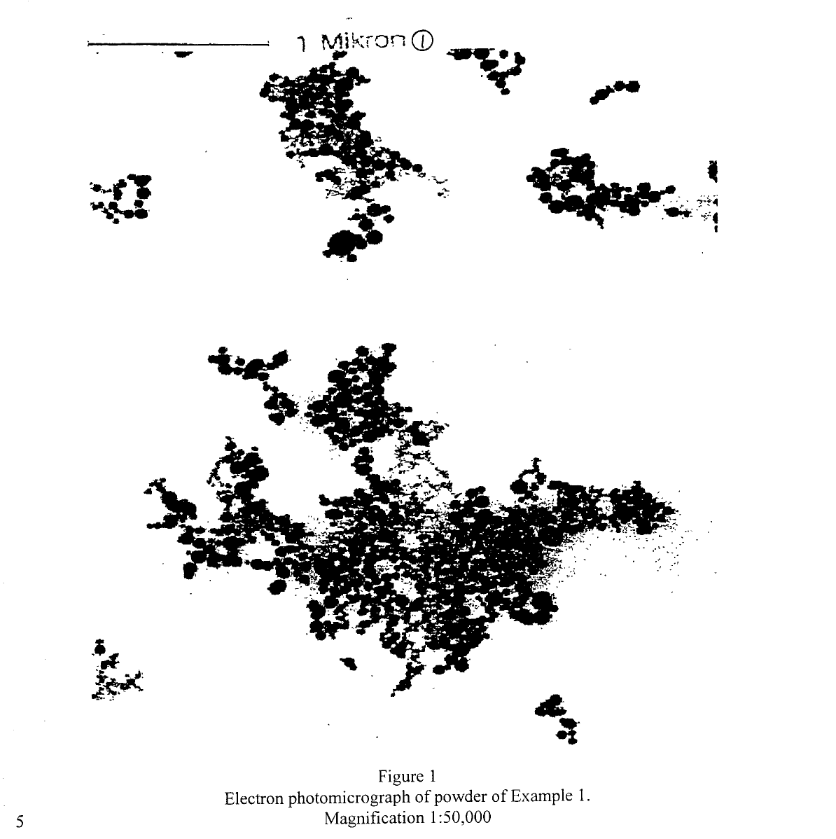

FIG. 1 shows an electron photomicrograph of the erbium oxide-doped pyrogenic silica of Example 1.

Magnification 1:50,000

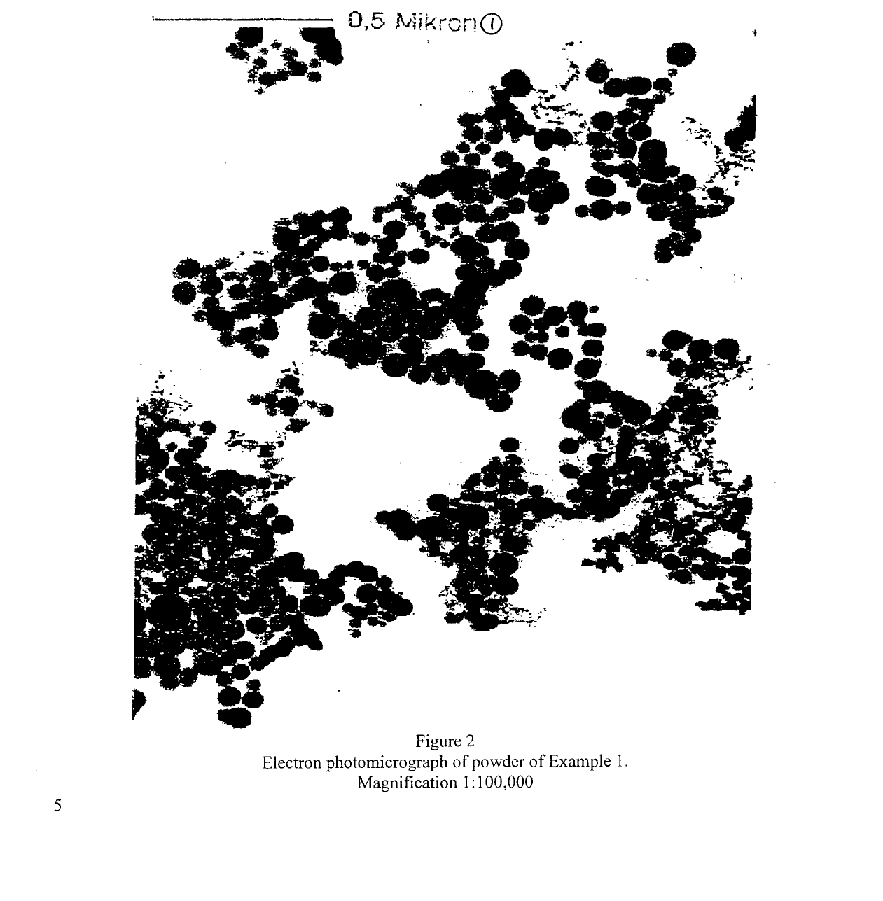

FIG. 2 shows an electron photomicrograph of the erbium oxide-doped pyrogenic silica of Example 1.

Magnification 1:100,000

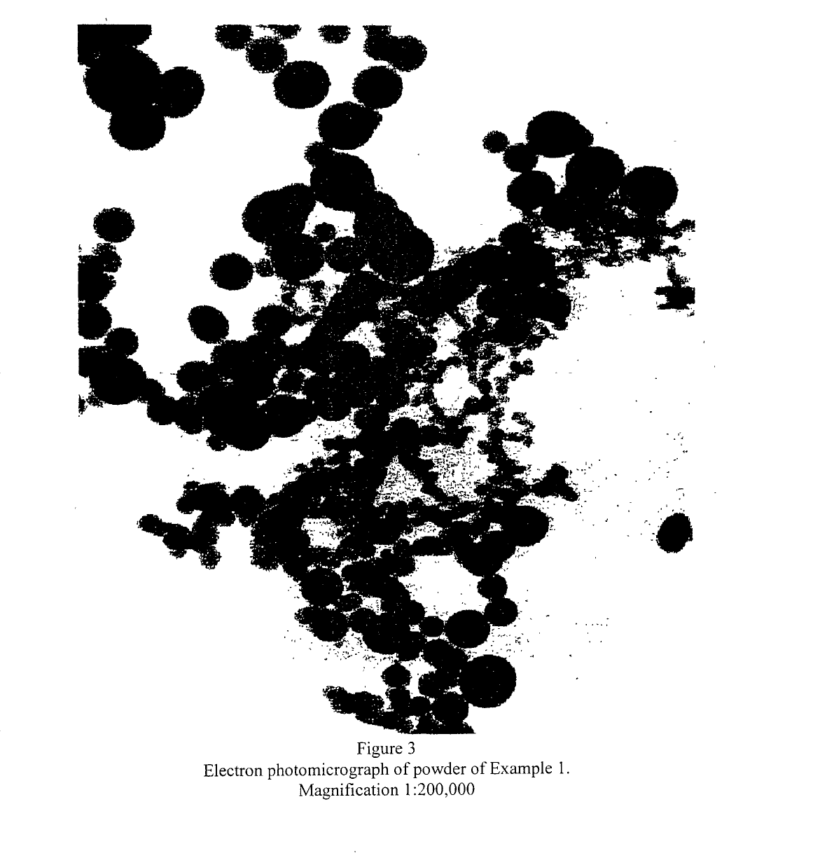

FIG. 3 shows an electron photomicrograph of the erbium oxide-doped pyrogenic silica of Example 1.

Magnification 1:200,000

It is apparent that, during doping with erbium salts, few aggregates that grow together or agglomerate are formed that uniformly contain erbium (oxide). This unexpected low structuring of the silicon dioxide doped with erbium according to the invention is favorable for the production of highly filled dispersions. The primary particle shape, which consists of not very aggregated spherical primary particles, has the same favorable effect.

The low degree of intergrowth of the particles is also apparent in the low DBP absorption (dibutyl phthalate absorption). For example, for pyrogenic silicon dioxide powder with a BET surface of about 50 m²/g, DBP absorption numbers from 100 to 200 would be expected, whereas the actually found values in the erbium oxide-doped powder lie below 100 g/100 g.

Further variations and modifications of the foregoing will be apparent to those skilled in the art and are intended to be encompassed by the claims appended hereto.

German priority application 101 34 382.5 is relied on and incorporated herein by reference.

We claim:

1. A pyrogenically produced oxide of at least one of a metal and metalloid doped with erbium oxide, comprising a base component which is a pyrogenically produced oxide, said base component being doped with erbium oxide in an amount of 0.000001 to 40 wt %, the BET surface of the doped oxide being from 1 to 1000 m²/g.

2. The pyrogenically produced oxide of at least one of a metal and metalloid doped with erbium oxide according to claim 1, wherein the base component is a pyrogenically produced oxide doped with erbium oxide in an amount of 0.000001 to 40 wt %, and the pH value of the doped pyrogenic oxide measured in a 4% aqueous dispersion of more than 5, and the BET surface of the doped oxide is from 1 to 1000 m²/g.

3. The pyrogenically produced oxide of least one of a metal and metalloid doped with erbium oxide according to claim 1, wherein the base component is a pyrogenically produced oxide doped with erbium oxide in an amount of 0.000001 to 40 wt %, and the dibutyl phthalate absorption of the powder is less than 100 g/l 100 g, and the BET surface of the doped oxide is from 1 to 1000 m²/g.

4. A method for production of a pyrogenic oxide doped with erbium oxide according to claim 1, comprising feeding an aerosol into a flame for production of pyrogenic oxide, said aerosol being formed from an erbium salt solution by atomization of said erbium salt solution through an aerosol generator, mixing the aerosol homogeneously before reaction with a gas mixture fed into the flame, to form an aerosol-gas mixture, reacting the aerosol-gas mixture in a flame and separating ormed pyrogenic oxides doped with erbium oxide from a gas stream.

5. Green compact or glass produced from the pyrogenically produced oxide according to claim 1.

6. A method of producing a green compact comprising forming a dispersion from the pyrogenically produced oxide of claim 1, forming a gel from said dispersion, and drying to form a green compact.

7. A method of making a glass with a homogeneous erbium oxide distribution comprising sintering the green compact obtained according to claim 6 at a sufficiently high temperature to form a bubble free glass.

8. A layered product comprising at least one layer being a densely sintered product obtained by the method of claim 7.

9. A method of producing a green compact comprising forming a dispersion from the pyrogenically produced oxide of claim 2, forming a gel from said dispersion, and drying to form a green compact.

10. A method of producing a green compact comprising forming a dispersion from the pyrogenically produced oxide of claim 3, forming a gel from said dispersion, and drying to form a green compact.

11. A method of making a glass with a homogeneous erbium oxide distribution comprising sintering the green compact obtained according to claim 9 at a sufficiently high temperature to form a bubble free glass.

12. A method of making a glass with a homogeneous erbium oxide distribution comprising sintering the green compact obtained according to claim 10 at a sufficiently high temperature to form a bubble free glass.

13. A glass fiber made with the pyrogenically produced oxide of claim 1.

14. A glass fiber made with the pyrogenically produced oxide of claim 2.

15. A glass fiber made with the pyrogenically produced oxide of claim 3.

16. An article containing glass made from the pyrogenically produced oxide of claim 1.

17. An article containing glass made from the pyrogenically produced oxide of claim 2.

18. An article containing glass made from the pyrogenically produced oxide of claim 3.

19. Aqueous dispersion of pyrogenic oxides doped with erbium or erbium oxide according to claim 1.

20. Aqueous dispersion of pyrogenic oxides doped with erbium or erbium oxide according to claim 2.

21. Aqueous dispersion of pyrogenic oxides doped with erbium or erbium oxide according to claim 3.
